(19) United States
(12) Patent Application Publication
(10) Pub. No.: US 2013/0288047 A1
(43) Pub. Date: Oct. 31, 2013

(54) TRANSPARENT CONDUCTIVE FILM AND MANUFACTURING METHOD THEREFOR

(71) Applicants: Daisuke Kajihara, Ibaraki-shi (JP); Tomotake Nashiki, Ibaraki-shi (JP)

(72) Inventors: Daisuke Kajihara, Ibaraki-shi (JP); Tomotake Nashiki, Ibaraki-shi (JP)

(73) Assignee: NITTO DENKO CORPORATION, Ibaraki-shi, Osaka (JP)

(21) Appl. No.: 13/997,466

(22) PCT Filed: Dec. 14, 2011
(86) PCT No.: PCT/JP2011/078875

§ 371 Date: Jun. 24, 2013

(30) Foreign Application Priority Data
Dec. 24, 2010 (JP) 2010-286948

(51) Int. Cl. H01B 1/08

(52) U.S. Cl. CPC H01B 1/08
USPC 428/336; 204/192.29; 428/332

(57) ABSTRACT

Disclosed is a highly productive method for manufacturing a transparent conductive film. The method includes the step of sputter depositing a transparent, amorphous tin-indium oxide conductive layer on a transparent substrate. The surface of the substrate, on which the transparent conductive layer is formed, has an arithmetic mean roughness Ra of 1.0 or less. The sputter depositing step is performed under an atmosphere having a water partial pressure of 0.1% or less based on an AR gas partial pressure at a base material temperature of more than 100° C. and 200° C. or less, using a metal target or oxide target in which the amount of tin atoms is more than 6% by weight and 15% by weight or less, based on the total weight of indium and tin atoms.

### TECHNICAL FIELD

The present invention relates to a transparent conductive film in which a transparent conductive layer is provided on a transparent base material, and a manufacturing method therefor.

### BACKGROUND ART

Touch panels are classified into an optical type, an ultrasonic type, a capacitance type, a resistive film type and the like according to the position detection method. A resistive film type touch panel has a structure in which a transparent conductive film and glass with a transparent conductive layer are so arranged as to face each other with a spacer interposed therebetween, and a current is passed through the transparent conductive film to measure a voltage at the glass with a transparent conductive layer. A capacitance type touch panel has as a basic structure a structure having a transparent conductive layer on a base material, and is used for vehicle-mount applications and the like because it has high durability and high transmittance. Particularly, in recent years, demands for capacitance type touch panels that allow multi-point input (multi-touch) have been increased, and requests for upsizing of screens and enhancement of response speed have also been increased at the same time.

Conventionally, for such touch panels, transparent conductive films have been widely used in which an indium.tin composite oxide (ITO) is formed on a transparent base material by a method such as a sputtering method. As a method for forming an ITO film on a transparent base material, a technique has been proposed in which a film is formed while oxygen in the film is kept at a low level, and the film is then heated under an oxygen atmosphere in the air to thereby convert the film from an amorphous film into a crystalline film (see, for example, Patent Documents 1 and 2). This method provides the advantage that the transparency of the film is improved, the resistance is decreased, and humidification heat reliability is improved.

On the other hand, demands for a transparent conductive film including an ITO film having a resistance lower than that of a conventional ITO film have been increased along with increased requests for upsizing of screens and improvement of response speed in touch panels. However, the conventional ITO film has such a problem that the resistance is not sufficiently decreased even by crystallization, or for achieving a decrease in resistance, much time is required for crystallization, leading to poor productivity.

### PRIOR ART DOCUMENTS

### Patent Documents

Patent Document 1: JP-B-03-15536

Patent Document 2: JP-A-2006-202756

### SUMMARY OF THE INVENTION

### Problems to be Solved by the Invention

In view of the above-described situations, it is an object of the present invention to provide, with high productivity, a transparent conductive film in which a low-resistance ITO film is formed on a transparent base material.

### Means for Solving the Problems

The present inventors have conducted vigorous studies, and resultantly found that when the surface roughness of a transparent base material, the ratio of indium and tin in a target for sputtering, and the ultimate degree of vacuum (water partial pressure) and the base material temperature during sputtering each fall within a predetermined range, an ITO film, which is crystallized even by short-time heating and the resistance of which can be decreased is formed, thus leading to completion of the present invention.

The present invention relates to a transparent conductive film having a transparent conductive layer including an In.Sn composite oxide on a transparent base material. The arithmetic mean roughness Ra of the surface of the transparent base material on which the transparent conductive layer is formed is preferably 1.0 nm or less. The amount of Sn atoms in the transparent conductive layer is preferably more than 6% by weight and 15% by weight or less based on the total weight of In atoms and Sn atoms. In the transparent conductive film of the present invention, the Hall mobility of the transparent conductive layer is preferably 10 to 35 cm²/V·s, and the carrier density thereof is preferably 6×10²⁰ to 15×10²⁰/m³. The thickness of the transparent conductive layer is preferably 15 to 50 nm.

Such a transparent conductive film can be manufactured by a base material providing step of providing a transparent base material, and a film formation step of sputter depositing a transparent conductive layer including an In.Sn composite oxide on the transparent base material.

In the film formation step, a metal target or oxide target is preferably used in which an amount of Si atoms is more than 6% by weight and 15% by weight or less based on the total weight of In atoms and Sn atoms. It is preferable to sputter deposit the transparent conductive layer at a base material temperature that is more than 100° C. and 200° C. or less under an atmosphere having a water partial pressure of 0.1% or less based on the Ar gas partial pressure.

The amorphous transparent conductive layer thus obtained preferably has a Hall mobility of 5 to 30 cm²/V·s, and preferably has a carrier density of 1×10² to 1×10²¹/cm³.

Further, the present invention relates to a method for manufacturing a transparent conductive film, which includes a heat treatment step of heating the amorphous transparent conductive layer to be crystallized. In the heat treatment step, it is preferred that the carrier density of the crystallized transparent conductive layer is increased as compared to that of the amorphous transparent conductive layer before crystallization.

### Effects of the Invention

In the present invention, an amorphous ITO film having a high Sn content is sputter deposited on a transparent base material having a predetermined surface roughness under predetermined conditions. Generally, an ITO film having a high Sn content is hard to be crystallized, but an ITO film formed under conditions according to the present invention can be fully crystallized by a relatively short-time heat treatment. In the heat-treated ITO film, the carrier density is increased as compared to the ITO film before heat treatment, and accordingly the resistance is decreased. Thus, according to the present invention, a transparent conductive film in which a low-resistance ITO film is formed on a transparent base material can be efficiently manufactured.

### BRIEF DESCRIPTION OF THE DRAWINGS

FIG. 1 is a schematic sectional view of a transparent conductive film according to one embodiment.

FIG. 2 is a schematic sectional view of a transparent conductive laminated body according to one application example of a transparent conductive film.

### MODE FOR CARRYING OUT THE INVENTION

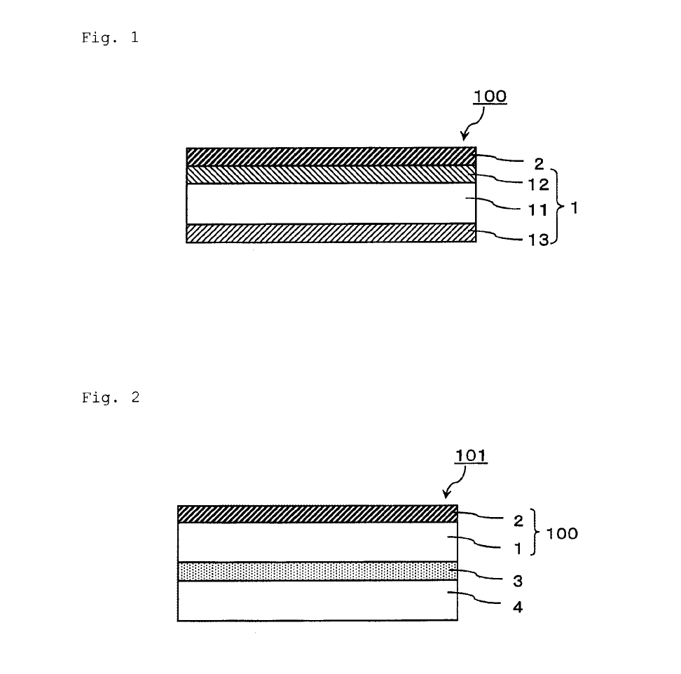

FIG. 1 is a schematic sectional view showing an embodiment of a transparent conductive film 100, wherein a transparent conductive layer 2 is formed on a transparent base material 1 including a transparent film 11 formed of an organic polymer molded product. The transparent conductive film 100 is obtained by a base material providing step of providing a transparent base material, and a film formation step of sputter depositing on the transparent base material a transparent conductive layer including an In.Sn composite oxide (ITC).

### <Base Material Providing Step>

The transparent base material 1 includes the transparent film 11 formed of an organic polymer molded product. As the transparent film 11, particularly a transparent film excellent in transparency and heat resistance is suitably used. Examples of the organic polymer include polyester-based polymers such as polyethylene terephthalate, polyolefin-based polymers, norbornene-based polymers, polymers of single component such as polycarbonate, polyether sulfone and polyarylate, copolymers and epoxy-based polymers. For the transparent film 11, film-shaped products, sheet-shaped products and other molded products of these organic polymers are suitably used.

The transparent base material 1 may be composed of only the transparent film 11, but as shown in FIG. 1, an undercoat layer 12 or a back surface coating layer 13 may be formed on the surface of the transparent film 11. FIG. 1 shows a configuration in which one undercoat layer 12 and one back surface coating layer 13 are formed, but these layers may be each composed of two or more layers. As the transparent base material 1, a transparent base material on which a birefringence layer including a liquid crystal monomer, a liquid crystal polymer or the like is formed can be used.

The arithmetic mean roughness Ra of the surface of the transparent base material 1 on which the transparent conductive layer 2 is formed is preferably 1.0 nm or less, more preferably 0.7 nm or less, further preferably 0.6 nm or less, especially preferably 0.5 nm or less. By decreasing the surface roughness of the transparent base material 1, the ITO film can be crystallized by relatively short-time heating, and in addition, the crystallized ITO film can be made to have a low resistance. A lower limit of the arithmetic mean roughness Ra of the surface of the transparent base is not particularly limited, but is preferably 0.1 nm or more, more preferably 0.2 nm or more, from the viewpoint of imparting a winding property in winding the base material in a roll form. The arithmetical mean roughness Ra is measured using an atomic force microscope (AFM, Nonoscope IV manufactured by Digital instruments, Inc.).

Generally, a film formed of an organic polymer molded product contains a filler or the like in the film from the viewpoint of productivity and handling properties, and therefore the arithmetic mean roughness Ra of the surface is often several nm or more. From the viewpoint of ensuring that the surface roughness of the transparent base material 1 within the aforementioned range, it is preferred that the undercoat layer 12 is formed on the surface of the transparent film 11 on which the transparent conductive layer 2 is formed. By forming the undercoat layer on the surface of the transparent film, the surface unevenness of the transparent film is reduced, so that the surface roughness can be decreased.

As a material of the undercoat layer 12, a dielectric material having transparency and a surface resistance of, for example, 1×10⁶ Ω/□ or more is suitably used. Examples of the material described above include inorganic substances such as NaF, Na₃AlF₆, LiF, MgF₂, CaF₂, BaF₂, BaF₂, SiO₂, LaF₃, CeF and Al₂O₃, organic substances such as an acryl resin, a urethane resin, a melamine resin, an alkyd resin, a cyclohexane-based polymer and an organic silane condensate, which have a refractive index of about 1.4 to 1.6, and mixtures of the inorganic substances and organic substances.

The undercoat layer 12 can be formed by a dry coating method such as a vacuum deposition method, a sputtering method or an ion plating method, a wet coating method (a coating method), or the like using the materials described above. In particular, the undercoat layer 12 is preferably formed by a wet coating method. When a plurality of undercoat layers are provided, it is preferred that at least one thereof is formed by a wet coating method. When the undercoat layer is formed by a wet coating method, the arithmetic means roughness Ra of the surface of the transparent base material 1 can be decreased to the predetermined range because the surface unevenness of the transparent film 11 is reduced and a uniform film is easily formed.

From the viewpoint of enhancement of adhesion between the transparent base material 1 and the transparent conductive layer 2, the surface of the transparent base material may be subjected to an appropriate treatment for tackiness such as a corona discharge treatment, an ultraviolet ray irradiation treatment, a plasma treatment or a sputter-etching treatment before the transparent conductive layer is formed.

As the back surface coating layer 13, for example, an anti-glare treatment layer or an anti-reflection treatment layer intended for improvement of visibility maybe provided, or a hard coating layer intended for protection of an outer surface may be provided. For the hard coating layer, a cured film formed of a curable resin such as a melamine-based resin, a urethane-based resin, an alkyd-based resin, an acryl-based resin or a silicone-based resin is preferably used. The back surface coating layer 13 may be provided on the transparent film 11 before the transparent conductive layer 3 is formed, or may be provided after the transparent conductive layer 3 is formed.

### <Film Formation Step>

In a film formation step, the amorphous transparent conductive layer (amorphous ITO film) 3 including an In.Sn composite oxide is formed on the transparent base material 1 by a sputtering method. It is to be noted that the “amorphous ITO” is not limited to a completely amorphous ITO, but may contain a small amount of crystalline components. Whether the ITO is amorphous or not can be determined by immersing a laminated body, in which a transparent conductive layer is formed on a base material, in hydrochloric acid having a concentration of 5% by weight for 15 minutes, then rinsing with water and drying the laminated body, and measuring a resistance between terminals at an interval of 15 mm using a tester. Since the amorphous ITO film is etched with hydrochloric acid to vanish, the resistance is increased due to immersing in hydrochloric acid. In this specification, the ITO is considered to be amorphous when the resistance between terminals at an interval of 15 mm exceeds 10 kΩ after immersing in hydrochloric acid, rinsing with water, and drying.

For formation of the transparent conductive layer, not only a standard magnetron sputtering method using a DC power source, but also various sputtering methods such as a RF sputtering method, a RF+DC sputtering method, a pulse sputtering method and a dual magnetron sputtering method can be employed.

A sputtering target for use in sputter deposition is preferably a metal target (In—Sn target) or oxide target (In₂O₃—SnO₂ target) in which the amount of Sn atoms is more than 6% by weight and 15% by weight or less based on the total weight of In atoms and Sn atoms. The amount of Sn atoms in the sputtering target is more preferably 7 to 14% by weight, further preferably 8 to 13% by weight based on the total weight of in atoms and Sn atoms.

The content of Sn in the sputtering target is substantially equal to the content of Sn in the transparent conductive layer 2, and if the content of Sn in the transparent conductive layer is too low, the specific resistivity is hard to be decreased when the amorphous ITO is heated to be crystallized, so that a low-resistance transparent conductive layer may not be obtained. On the other hand, a part of Sn, which is not incorporated into In₂O₃ crystal lattices, may act like an impurity to hinder crystallization. Thus, if the content of Sn is too high, a fully crystallized ITO film may be hard to be obtained, or much time may be required for crystallization.

Sputter deposition using the target described above is carried out by introducing an Ar gas as an inert gas into a sputtering device that is evacuated to a high vacuum. When a metal target of In-Sn is used as a sputtering target, an oxidant such as an oxygen gas is introduced together with an Ar gas to carry out reactive sputter deposition. When an oxide target of In₂O₃—SnO₂ is used, an oxygen gas or the like may also be introduced in addition to an Ar gas.

Presence of water molecules in a film formation atmosphere terminates a dangling bond occurring during film formation, and thus hinders crystal growth of ITO, and therefore the water partial pressure in the film formation atmosphere is preferably low. The water partial pressure during film formation is preferably 0.1% or less, more preferably 0.07% or less with respect to the Ar gas partial pressure. The water partial pressure during film formation is preferably 2×10⁻⁴ Pa or less, more preferably 1.5×10⁻⁴ Pa or less, preferably 1×10⁻⁴ Pa or less. For ensuring that the water partial pressure during film formation falls within the above-described range, it is preferred that before the start of film formation, the interior of the sputtering device is evacuated to 2×10⁻⁴ Pa or less, preferably 1.5×10⁻⁴ Pa or less, more preferably 1×10⁻⁴ Pa or less so that the water partial pressure falls within the above-described range to obtain the atmosphere that impurities such as moisture in the device and organic gases generated from the base material are removed.

The base material temperature during sputter deposition is preferably more than 100° C. By setting the base material temperature to more than 100° C., crystallization of the ITO film in the heat treatment step described below is facilitated even in the case of an ITO film having a high content of Sn atoms, and hence a low-resistance crystalline ITO film is obtained. Thus, from the viewpoint of obtaining a crystalline transparent conductive layer which is a low-resistance film when the transparent conductive layer 2 is heated to be crystallized, the base material temperature is more preferably 120° C. or more, further preferably 130° C. or more, especially preferably 140° C. or more. From the viewpoint of suppressing thermal damage to the base material, the base material temperature is preferably 200° or less, more preferably 180° C. or less, further preferably 170° C. or less, especially preferably 160° C.

In this specification, the “base material temperature” is a set temperature of a ground for the base material during sputter deposition. For example, the base material temperature when sputter deposition is carried out continuously by a roll sputtering device is a temperature of a can roll on which sputter deposition is carried out. The base material temperature when sputter deposition is carried out in a single sheet process (batch process) is a temperature of a base material holder for placing the base material.

The thickness of the transparent conductive layer during sputter deposition is preferably 15 to 50 nm, more preferably 20 to 30 nm. If the thickness of the amorphous transparent conductive layer is excessively small, the ITO film may be hard to be crystallized in the subsequent heat treatment step. If the thickness is more than 30 nm, the transparent conductive film may be poor in quality when used for a touch panel such that the resistance is extremely decreased when the transparent conductive layer is crystallized, or the transparency and flexibility of the transparent conductive film are deteriorated.

The amorphous transparent conductive layer sputter deposited on the base material as described above preferably has a Hall mobility of 5 to 30 cm²/V·s, and preferably has a carrier density of 1×10²⁰ to 10×10²⁰/cm³. By employing film formation conditions described above, the Hall mobility and carrier density can be made to fall within the aforementioned range.

The transparent conductive film thus obtained may be directly put to practical use for a touch panel, but also may be subjected to a heat treatment step to heat the amorphous ITO film to be converted into a crystalline transparent conductive layer (crystalline ITO film).

When the transparent conductive film is used in a projection-type capacitance type touch panel, a matrix-type resistive film type touch panel, or the like, the transparent conductive layer may be patterned in a predetermined form (e.g. strip form), but when the ITO film is crystallized by a heat treatment, etching processing with an acid becomes difficult. On the other hand, the amorphous ITO film before the heat treatment can be easily etching-processed. Thus, when the transparent conductive layer is patterned by etching, it is preferred to carry out the etching after formation of the transparent conductive layer and before the heat treatment step.

### <Heat Treatment Step>

The heat treatment step is a step of heating a sputter deposited amorphous transparent conductive layer to be crystallized. The heating temperature and heating time are appropriately selected so that the ITO of the transparent conductive layer is fully crystallized. Here, “full crystallization” refers to a state in which crystallized grains are present over the entire surface when an observation is made with a transmission electron microscope (TENT).

The heating temperature in the heat treatment step is preferably 120° C. to 160° C., more preferably 125° C. to 160° C., further preferably 130° C. to 160° C. The heating time is preferably 120 minutes or less, more preferably 90 minutes or less, further preferably 60 minutes or less. By appropriately selecting the heating temperature and heating time, the ITO film can be converted into a fully crystallized film without causing deterioration in terms of productivity and quality. The heating time is preferably 30 minutes or more from the viewpoint of fully crystallizing the ITO film.

Generally, an ITO film in which the content of Sn is more than 6% by weight based on the total weight of In atoms and Sn atoms is hard to be crystallized, and should be heated, for example, at 140° C. or more for 2 hour or more for fully crystallizing the ITO film. In contrast, by using a base material having a small surface roughness and sputter depositing an amorphous ITO film under predetermined conditions as described above, the ITO film can be fully crystallized under relatively low-temperature and short-time heating conditions.

As a result of investigating the reason why by crystallization, the resistant can be decreased more significantly as compared to previous films, it has been found that according to the present invention, the carrier density of the transparent conductive layer is significantly increased while the Hall density thereof is not significantly changed before and after crystallization. That is, the Hall mobility after crystallization is about 5 to 35 cm²/V·s, and is not significantly changed as compared to the Hall mobility of about 5 to 30 cm²/V·s before crystallization, whereas the carrier density after crystallization is about 6×10²⁰ to 15×10²⁰/cm³, and is significantly increased as compared to the carrier density of about 1×10²⁰ to 10×10²⁰/cm³ before crystallization, and this is presumed to contribute to the decrease in resistance.

In other words, in the present invention, it is preferred that the carrier density of the crystalline transparent conductive layer after the heat treatment step is increased in comparison with the amorphous transparent conductive layer before being subjected to the heat treatment step, from the viewpoint of obtaining a low-resistance crystalline ITO film. The carrier density is increased more preferably by a factor of 1.5 or more, further preferably by a factor of 2 or more.

The transparent conductive film obtained by the step described above can be used directly for various kinds of applications such as touch panels. A transparent conductive laminated body 101 can also be formed by bonding a transparent substrate 4 to the surface of the transparent base material 1 opposite to the surface, on which the transparent conductive layer 2 is formed, with a transparent pressure-sensitive adhesive layer 3 interposed therebetween as shown in FIG. 2.

For bonding of the transparent substrate 4 to the transparent conductive film 100, the transparent substrate 4 may be provided with the pressure-sensitive adhesive layer 3, to which the transparent conductive film 100 (on the transparent base material 1 side) is bonded, or conversely the transparent conductive film 100 (on the transparent base material 1 side) may be provided with the pressure-sensitive adhesive layer 3, to which the transparent substrate 4 is bonded. The latter method is more advantageous in terms of productivity because the pressure-sensitive adhesive layer can be continuously formed with the transparent conductive film formed into a roll.

For the pressure-sensitive adhesive layer, any material can be used without particular limitation as long as it has transparency. For example, an acryl-based pressure-sensitive adhesive, a silicone-based pressure-sensitive adhesive, a rubber-based pressure-sensitive adhesive, or the like is used. This pressure-sensitive adhesive layer has a function of improving the scratch resistance of the transparent conductive layer and dotting properties as intended for use in a touch panel owing to its cushion effect after the transparent substrate is attached.

The transparent substrate bonded to the film base material with the pressure-sensitive adhesive layer interposed therebetween can impart a satisfactory mechanical strength to the film base material, and contribute particularly to prevention of occurrence of curl and the like. When the transparent conductive laminated body after bonding of the transparent substrate is required to have flexibility, a plastic film having a thickness of about 6 to 300 μm is normally used as a transparent substrate, and when flexibility is not particularly required, a glass plate or a film-shaped or plated-shaped plastic having a thickness of about 0.05 to 10 mm is normally used. As a material of the plastic, mention is made of a material similar to that of the aforementioned transparent film.

The transparent conductive film manufactured in this way is suitably used for formation of transparent electrodes of various kinds of devices, and touch panels. In particular, the transparent conductive film obtained according to the present invention can be suitably used for touch panels of display devices, for which capsizing of screens and high response performance are desired, because the ITO film has a low resistance. The transparent conductive film of the present invention is excellent in humidity and heat resistance performance, and therefore can be suitably used for various kinds of applications, for which excellent environmental resistance performance at a high temperature and high humidity is desired, in addition to the touch panels.

### EXAMPLES

The present invention will be described below with reference to Examples, but the present invention is not limited to Examples described below. Evaluations in Examples were performed in accordance with the following methods.

### (Arithmetic Mean Roughness)

The arithmetical mean roughness was measured using an atomic force microscope (AFM, Nanscope IV manufactured by Digital Instruments, Inc.).

### (Hall Mobility and Carrier Density)

The Hall mobility and carrier density of a transparent conductive layer before a heat treatment step (immediately after sputtering) and after the heat treatment step were measured using a hall effect measurement system (product name “HL5500PC” manufactured by Bio-Rad Laboratories, Inc.).

### (Transmittance)

The total light transmittance was measured in accordance with JIS K7105 using a haze meter (manufactured by Suga Test Instruments Co., Ltd.).

### (Surface Resistance)

The surface resistance (Ω/□) of an ITO film was determined by a four-terminal method. A transparent conductive film was immersed in hydrochloric acid having a concentration of 5% by weight for 15 minutes, and rinsed with water and dried, and thereafter the surface resistance was measured to determine whether the film was crystallized or not.

### Example 1

### (Preparation of Transparent Base Material)

A thermosetting resin including a melamine resin, an alkyd resin and an organic silane condensate at a weight ratio of 2:2:1 was deposited as an undercoat layer in a thickness of 35 nm on one surface of a film base material formed of a polyethylene terephthalate film (hereinafter, referred to as a PET film) having a thickness of 23 μm. The arithmetical mean roughness Ra of the surface of the undercoat layer was 0.5 nm.

### (Film Formation of Transparent Conductive Layer)

A transparent conductive thin film (hereinafter, referred to as an ITO film) having a thickness of 25 nm and including an indium.tin composite oxide was formed on the undercoat layer by a reactive sputtering method using a sintered material of 90% by weight of indium oxide and 10% by weight of tin oxide in an atmosphere at 0.4 Pa including 98% by volume of argon gas and 2% by volume of oxygen gas. In film formation, the interior of a sputtering device was evacuated until the water partial pressure during film formation was 8.0×10⁻⁵ Pa, an argon gas and an oxygen gas were then introduced, and a film was formed in an atmosphere at a base material temperature of 140° C. and a water partial pressure of 8.0×10⁻⁵ Pa. The water partial pressure at this time was 0.05% based on the argon gas partial pressure.

The transparent conductive layer of the transparent conductive film thus obtained was observed with a transmission electron microscope (TEM) of 25000 magnifications, which showed that the layer was not fully crystallized. As shown in Table 1, it is apparent that the ITO film is amorphous because the transparent conductive layer was etched by immersing in hydrochloric acid and the resistance value is ∞.

### (Heat Treatment)

The transparent conductive film, in which an amorphous ITO film was formed on the transparent base material, was heat-treated by heating the film at 140° C. for 90 minutes, so that the ITO film was crystallized. The heat-treated transparent conductive layer of the transparent conductive film was observed with a transmission electron microscope (TEM) of 25000 magnifications, which showed that the ITO film was fully crystallized. As shown in Table 1, there is no change in resistance value after immersing in hydrochloric acid, and it is apparent that a crystalline ITO film which is not etched with an acid is formed.

### Example 2

A transparent conductive thin film was formed on a transparent base material in the same manner as in Example 1 except that the sputtering device was evacuated until the water partial pressure was 2.0×10⁻⁴ Pa, and then an argon gas and an oxygen gas were introduced to form the film in film formation of the transparent conductive layer in Example 1, and thereafter a heat treatment was carried out at 140° C. for 120 minutes to obtain a transparent conductive film in which a fully crystallized ITO film was formed on a transparent base material. The water partial pressure during film formation was 2.0×10⁻⁴ Pa, and was 0.10% based on the argon gas partial pressure.

### Example 3

A transparent conductive thin film was formed on a transparent base material in the same manner as in Example 1 except that the base material temperature was 120° C. in film formation of the transparent conductive layer in Example 1, and thereafter a heat treatment was carried out at 140° C. for 90 minutes to obtain a transparent conductive film in which a fully crystallized ITO film was formed on a transparent base material.

### Comparative Example 1

A sintered material of 97% by weight of indium oxide and 3% by weight of tin oxide was used in place of the sintered material of 90% by weight of indium oxide and 10% by weight of tin oxide in film formation of the transparent conductive layer in Example 1. Otherwise in the same manner as in Example 1, a transparent conductive layer was formed on a transparent base material, and thereafter a heat treatment was carried out to obtain a transparent conductive film in which a fully crystallized ITO film was formed on a transparent base material.

### Comparative Example 2

An undercoat layer of SiO₂ having a thickness of 30 nm was formed by a vacuum deposition method instead of forming a thermosetting resin layer as an undercoat layer on one surface of a PET film in preparation of the transparent base material in Example 1. The arithmetic average roughness Ra of the surface of the transparent base material on which the undercoat layer was formed was 2.0 nm. A transparent conductive layer was formed on the undercoat layer in the same manner as in Example 1, and thereafter a heat treatment was carried out at 140° C. for 120 minutes to obtain a transparent conductive film.

### Comparative Example 3

A transparent conductive thin film was formed on a transparent base material in the same manner as in Example except that the sputtering device was evacuated until the water partial pressure was 4.0×10⁻⁴ Pa, and then an argon gas and an oxygen gas were introduced to form the film in film formation of the transparent conductive layer in Example 1, and thereafter a heat treatment was carried out at 140° C. for 120 minutes to obtain a transparent conductive film in which a fully crystallized ITO film was formed on a transparent base material. The water partial pressure during film formation was 4.0×10⁻⁴ Pa, and was 0.20% based on the argon gas partial pressure.

### Comparative Example 4

A transparent conductive thin film was formed on a transparent base material in the same manner as in Example 1 except that the base material temperature during film formation was 80° C. in formation of the transparent conductive layer in Example 1, and thereafter a heat treatment was carried out at 140° C. for 120 minutes to obtain a transparent conductive film in which a fully crystallized ITO film was formed on a transparent base material.

Manufacturing conditions and results of evaluation of transparent conductive films for Examples and Comparative Examples described above are shown in Table 1.

TABLE 1

| | | Film formation step | | | | | Evaluation | |
|---|---|---|---|---|---|---|---|---|
| | | | Ratio of | | Heat treatment | | results | |
| | Base | | water | Base | step | | Hall mobility | |
| | material | Sn | partial | material | Heating | Heating | (cm²/V · s) | |
| | Ra | content | pressure | temperature | temperature | time | Before | After |
| | (nm) | (wt %) | (Water/Ar) | (° C.) | (° C.) | (min) | heating | heating |
| Example 1 | 0.5 | 10 | 0.05 | 140 | 140 | 90 | 20.0 | 26.0 |
| Example 2 | 0.5 | 10 | 0.10 | 140 | 140 | 120 | 20.0 | 26.0 |
| Example 3 | 0.5 | 10 | 0.05 | 120 | 140 | 90 | 20.0 | 26.0 |
| Comparative | 0.5 | 3 | 0.05 | 140 | 140 | 90 | 21.2 | 36.9 |
| Example 1 | | | | | | | | |
| Comparative | 2.0 | 10 | 0.05 | 140 | 140 | 120 | 20.0 | 21.6 |
| Example 2 | | | | | | | | |
| Comparative | 0.5 | 10 | 0.20 | 140 | 140 | 120 | 20.0 | 21.5 |
| Example 3 | | | | | | | | |
| Comparative | 0.5 | 10 | 0.05 | 80 | 140 | 120 | 20.0 | 25.0 |
| Example 4 | | | | | | | | |

| | Evaluation results | | | | | | | |
|---|---|---|---|---|---|---|---|---|
| | | | | | Surface | | | |
| | | | | | resistance | | | |
| | | | | | after | | | |
| | | | | | immersing in | | | |
| | Carrier | | Surface | | hydrochloric | | Total light | |
| | density | | resistance | | acid | | transmittance | |
| | (10²⁰/cm³) | | (Ω/□) | | (Ω/□) | | (%) | |
| | Before | After | Before | After | Before | After | Before | After |
| | heating | heating | heating | heating | heating | heating | heating | heating |
| Example 1 | 2.9 | 7.3 | 440 | 139 | ∞ | 139 | 86.8 | 89.5 |
| Example 2 | 3.0 | 7.5 | 450 | 140 | ∞ | 140 | 87.0 | 89.5 |
| Example 3 | 3.0 | 7.5 | 450 | 140 | ∞ | 140 | 87.0 | 89.5 |
| Comparative | 3.7 | 2.9 | 450 | 265 | ∞ | 265 | 86.0 | 87.0 |
| Example 1 | | | | | | | | |
| Comparative | 2.9 | 3.1 | 450 | 400 | ∞ | ∞ | 87.0 | 88.0 |
| Example 2 | | | | | | | | |
| Comparative | 2.9 | 3.0 | 450 | 400 | ∞ | ∞ | 87.0 | 88.0 |
| Example 3 | | | | | | | | |
| Comparative | 3.0 | 5.5 | 450 | 165 | ∞ | ∞ | 87.0 | 88.5 |
| Example 4 | | | | | | | | |

According to Table 1, in each of Examples 1 to 3, the surface resistance of the ITO film is decreased to ⅓ or less due to crystallization, so that a low-resistance crystalline ITO film is obtained. This is presumed to be because the carrier density is significantly increased at the time of crystallization. Further, it is apparent that in Examples to 3, the total light transmittance is increased by 2% or more before and after the heating step, so that a transparent conductive film having a high transparency is obtained.

In particular, in Examples 1 and 3 in which the sputtering device was evacuated so that the water partial pressure during formation of the ITO film was 0.05% based on the Ar partial pressure, a fully crystallized ITO film was obtained by heating at 140° C. for 90 minutes, and it is apparent that crystallization could be achieved in a shorter time as compared to Example 2. On the other hand, in Comparative Example 3 in which the water partial pressure during formation of the ITO film was 0.2% based on the Ar partial pressure, the surface resistance was after the heated transparent conductive film was immersed in hydrochloric acid. This is because the transparent conductive layer in Comparative example 3 was an amorphous ITO film that was not fully crystallized, and was therefore etched with hydrochloric acid. That is, comparison of Examples 1 and 2 and Comparative Example 3 shows that by decreasing the water partial pressure during formation of the ITO film, an amorphous ITO film capable of being crystallized even in a short time is obtained, and by heating the amorphous ITO film to be crystallized, a low-resistance ITO crystallized ITO film is obtained.

In Comparative Example 1 using a sputtering target having a low tin content, full crystallization of the ITO film is completed by a heat treatment similar to that in Example 1, but the surface resistance after crystallization is about 60% of the surface resistance before crystallization, so that a low-resistance ITO film is not obtained. In Comparative Example 1, the Hall mobility is increased by a factor of about 1.5, whereas the carrier density is decreased, as compared to before crystallization, so that the mechanism of decreasing the resistance is considered to be different from that in Examples 1 to 3.

In Comparative Example 2 using a transparent base material having a high Ra, the level of decrease in surface resistance after heating is low despite that film formation and heating treatment were carried out under conditions similar to those in Example 1. Further, in Comparative Example 2, the surface resistance is ∞ after the heated transparent conductive film was immersed in hydrochloric acid, and thus crystallization is not sufficient. Comparison of Example 1 and Comparative Example 2 shows that by decreasing the arithmetic means roughness Ra of the surface of the transparent base material on which the transparent conductive layer is formed, a low-resistance crystallized ITO film is obtained by short-time heating.

In Comparative Example 4 in which the base material temperature during formation of the ITO film is low, i.e. 80° C., the resistance has been decreased sufficiently as compared to Comparative Examples 1 and 2, but a decrease in resistance comparable to that in Examples 1 to 3 has not been achieved. Further, in Comparative Example 4, the surface resistance is ∞ after the heated transparent conductive film is immersed in hydrochloric acid, and thus crystallization is not sufficient.

As described above with Examples compared to Comparative Examples, according to the present invention, a transparent conductive film in which a crystalline ITO film is formed on a transparent base material can be efficiently manufactured, and the crystalline ITO film obtained has a low resistance because it has a high carrier density.

### DESCRIPTION OF REFERENCE SIGNS

1 transparent base material

11 transparent film

12 undercoat layer

13 back surface coating layer

2 transparent conductive layer

3 pressure-sensitive adhesive layer

4 transparent substrate

100 transparent conductive film

101 transparent conductive laminated body

1. A method for manufacturing a transparent conductive film, comprising a base material providing step of providing a transparent base material; and a film formation step of sputter depositing a transparent conductive layer including an In.Sn composite oxideon the transparent base material,
wherein an arithmetic mean roughness Ra of a surface of the transparent base material on which the transparent conductive layer is formed is 1.0 nm or less;and
in the film formation step,
an amorphous transparent conductive layer including an In.Sn composite oxide is formed by sputter deposition under an atmosphere having a water partial pressure of 0.1% or less based on an Ar gas partial pressure at a base material temperature of more than 100° C. and 200° C. or less
using a metal target or oxide target in which an amount of Sn atoms is more than 6% by weight and 15% by weight or less based on the total weight of In atoms and Sn atoms.

2. The method for manufacturing a transparent conductive film according to claim 1, wherein the water partial pressure in the film formation step is 2×10⁻⁴ Pa or less.

3. The method for manufacturing a transparent conductive film according to claim 1, wherein the amorphous transparent conductive layer has a Hall mobility of 5 to 30 cm²/V·s and a carrier density of 1×10²⁰ to 10×10²⁰/cm³.

4. The method for manufacturing a transparent conductive film according to claim 1, wherein in the film formation step, the transparent conductive layer is formed in a thickness of 15 to 50 nm.

5. The method for manufacturing a transparent conductive film according to claim 1, wherein the method further comprises a heat treatment step of heating the amorphous transparent conductive layer to be converted into a crystalline transparent conductive layer.

6. The method for manufacturing a transparent conductive film according to claim 5, wherein in the heat treatment step, the carrier density of the crystalline transparent conductive layer is increased as compared to the amorphous transparent conductive layer before conversion.

7. The method for manufacturing a transparent conductive film according to claim 5, wherein the crystalline transparent conductive layer has a Hall mobility of 10 to 35 cm²/V·s and a carrier density of 6×10²⁰ to 15×10²⁰/cm³.

8. A transparent conductive film comprising a transparent conductive layer including an In.Sn composite oxideon a transparent base material,
wherein an arithmetic mean roughness Ra of a surface of the transparent base material on which the transparent conductive layer is formed is 1.0 nm or less;
an amount of Sn atoms in the transparent conductive layer is more than 6% by weight and 15% by weight or less based on the total weight of In atoms and Sn atoms; and
the transparent conductive layer has a Hall mobility of 10 to 35 cm²/V·s and a carrier density of 6×10²⁰ to 15×10²⁰/cm³.

9. The transparent conductive film according to claim 8, wherein a thickness of the transparent conductive layer is 15 to 50 nm.
